(19) United States
(12) Patent Application Publication
(10) Pub. No.: US 2026/0177702 A1
(43) Pub. Date: Jun. 25, 2026

(54) METHOD AND DEVICE FOR THREE-DIMENSIONAL IMAGING AND IMAGING THROUGH SCATTERING SCENES

(71) Applicants: Arizona Board of Regents on Behalf of the University of Arizona, Tucson, AZ (US); Northwestern University, Evanston, IL (US)

(72) Inventors: Florian Willomitzer, Tucson, AZ (US); Oliver Cossairt, Evanston, IL (US); Manuel Ballester, Evanston, IL (US); Heming Wang, Evanston, IL (US)

(21) Appl. No.: 19/132,572

(22) PCT Filed: Nov. 22, 2023
(86) PCT No.: PCT/US2023/080934

§ 371 Date: May 23, 2025

Related U.S. Application Data
(60) Provisional application No. 63/384,838, filed on Nov. 23, 2022.

(51) Int. Cl. G01S 17/894; G01S 7/481; G01S 17/36; G06T 7/521

(52) U.S. Cl. CPC G01S 17/894; G01S 7/4815; G01S 17/36; G06T 7/521

(57) ABSTRACT

Methods, devices and systems are described that produce improved images and improved knowledge of object characteristics, and enable acquisition of two- or three-dimensional images through dynamic scattering media, such as living (moving) tissue, turbid fluids, or fog. One method for time-of-flight sensing includes illuminating the object with a laser having at least two spectrally-separated components, and simultaneously receiving at a detector: a first reference beam consisting of the first spectral component, a second reference beam consisting of the second spectral component, and an object beam. The first or the second reference beams produce a first combination of the first reference beam and the object beam with a non-overlapping spectral content with respect to a second combination of the second reference beam and the object beam. The method also includes determining a field value, an image, a phase value or a depth profile for the object based on the detected signals.

### CROSS-REFERENCE TO RELATED APPLICATION(S)

This application claims priority to the provisional application with Ser. No. 63/384,838, titled “METHOD AND DEVICE FOR 3D IMAGING AND IMAGING THROUGH SCATTERING SCENES,” filed Nov. 23, 2022. The entire contents of the above noted provisional application are incorporated by reference as part of the disclosure of this document.

### TECHNICAL FIELD

The technology described in this patent document generally relates to imaging and more particularly to techniques that involve time-of flight sensing.

### BACKGROUND

Three-dimensional (3D) imaging techniques are progressively replacing conventional photographs, which cannot capture the complexity of real-world objects. A 3D model provides information about an object's surface shape, slope, or texture-essential properties in object analysis. Once we obtain a realistic 3D model of an object, we can reproduce it under different illuminations and rigid transformations using computer graphics techniques. These features make 3D imaging very useful for many applications, including medical diagnostic imaging, quality inspection of manufactured products, augmented reality/virtual reality (SR/VR) and autonomous driving. It is beneficial to develop techniques for improved 3D imaging that is proliferating in many applications.

### SUMMARY

The disclosed embodiments, among other features and benefits, produce improved images of objects and improved knowledge of object characteristics. These can be obtained in 2D or 3D for objects that are imaged through dynamic scattering media, such as living (moving) tissue, turbid fluids, or fog.

An example method for time-of-flight sensing includes illuminating an object with a laser beam including a combination of at least two spectrally-separated components, where a first spectral component of the laser beam has a first wavelength and a second spectral component of the laser beam has a second wavelength different than the first wavelength. The method further includes simultaneously receiving at a detector: a first reference beam consisting of the first spectral component of the laser beam, a second reference beam consisting of the second spectral component of the laser beam, and an object beam produced based on interactions of the laser beam with the object. The first reference beam or the second reference beam are positioned to produce a first combination of the first reference beam and the object beam that has a non-overlapping spectral content with respect to a second combination of the second reference beam and the object beam. The method also includes determining one or more of a field value, an image, a phase value or a depth profile associated with the object based on information corresponding to signals detected by the detector.

### BRIEF DESCRIPTION OF THE DRAWINGS

FIG. 1 illustrates a diagram of a single shot time-of-flight (ToF) camera system and associated processing in accordance with an example embodiment.

FIG. 2 illustrates a benchtop experimental setup of an optical system in accordance with an example embodiment.

FIG. 3 illustrates an example double-shot acquisition results in accordance with an example embodiment.

FIG. 4 illustrates an example single-shot acquisition results in accordance with an example embodiment.

FIG. 5 illustrates an example single-shot measurement results for a dynamic object in accordance with an example embodiment.

FIG. 6 illustrates a single-shot non-line-of-sight (NLoS) system and the associated measurements through a scattering scene in accordance with an example embodiment.

FIG. 7 illustrates an example configuration where a hidden object can be detected based on the disclosed technology.

FIG. 8 illustrates a set of operations that can be carried out for time-of-flight sensing in accordance with an example embodiment.

FIG. 9 illustrates a set of operations that can be carried out for time-of-flight sensing in accordance with another example embodiment.

### DETAILED DESCRIPTION

The existing 3D imaging techniques can be mainly classified into three groups. The first group corresponds to triangulation-based techniques, which are one of the most used techniques in industrial inspection or 3D metrology on macroscopic rough surfaces. Examples include active and passive stereo, line- or fringe-projection techniques, or focus-searching methods. However, the precision of related methods scales with the stand-off distance, and occluded parts of the object cannot be measured. The second group refers to all reflection-based methods, which typically use specific lighting conditions and then study the light reflected or scattered off the object's surface to estimate its surface slope. Some examples include photometric stereo and deflectometry. These systems often become highly complicated to calibrate, and the integration from surface normal to surface shape is problematic in some cases. The third category corresponds to all Time-of-Flight-based (ToF) approaches, that calculate the optical pathlength between camera and object or scene to obtain its shape. All kinds of so-called “ToF cameras” (e.g., pulsed, amplitude modulated) and optical Interferometers are prominent examples for this group. While the conventional ToF cameras directly measure the travel time of light, interferometric cameras measure the optical pathlength difference via interference patterns produced by an object and a reference beam. ToF-based approaches are beneficial for many applications because they are robust to occlusions and the data precision does not depend on the standoff distance of the camera.

Conventional “ToF cameras” often exploit amplitude-modulated light sources, either as pulsed illumination (LIDAR) or in the form of “continuous waves with amplitude modulation” (CWAM). These cameras generally require specific sensor architectures with a high temporal resolution. The main restriction of those cameras is their limited pixel resolution and their low depth precision, which is roughly on the order of centimeters. This makes conventional ToF cameras useful for basic estimation or detection tasks of larger objects (for example, to know if there is an object in front of an autonomous driving vehicle, or to estimate the pose of a human). However, they cannot be used for applications that require high data precision, such as specific tasks in medical imaging, industrial inspection, or optical metrology. Moreover, some ToF camera schemes require a sequence of exposures to calculate a 3D scene, or exploit raster-scanning of a laser dot (i.e., are not “single-shot”), which makes them susceptible to fast object motions.

Another drawback of standard (single wavelength) interferometric ToF cameras is that they are limited to the measurement of objects with optically smooth (specular) surfaces. When an optically rough surface is illuminated with coherent light, the backscattered field forms a so-called “speckle pattern.” As the phase of this speckle field is randomized, we cannot recover information about the optical pathlength difference and hence, the depth map of the object. In practice, standard interferometric techniques become helpful only in particular fields, e.g., to study the nanomechanical motion of some objects, or for high precision surface testing of lenses or smooth technical parts. Nevertheless, multifrequency interferometric ToF cameras have shown that these principles can also extend to macroscopic objects with rough surfaces. Related methods use the information from two (or more) interferometric measurements at different optical wavelengths to disambiguate the random phase fluctuations of the object beam. Recent implementations of these techniques in computer vision still require exotic sensors and/or are limited to static objects, i.e., are not motion-robust.

The disclosed embodiments overcome the shortcomings of the prior systems and, among other features and benefits, produce improved images of objects and improved knowledge of object characteristics, which can be obtained in 2D or 3D for objects that are imaged through dynamic scattering media, such as living (moving) tissue, turbid fluids, or fog.

The disclosed technology can be implemented in various embodiments to provide a multifrequency interferometric ToF camera that is capable of scanning object surfaces in a single shot with up to submillimeter depth precision. Here, single shot means that only one camera image is necessary to produce the assessment of the object. This feature makes the disclosed ToF cameras and associated methods robust against object motion.

Moreover, the disclosed camera systems can be produced using off-the-shelf CMOS or CCD detector technology, and even using standard smartphone cameras. For instance, no specialized detector architecture (like PMDs, SPADs, or lock-in detectors) is required, simplifying the design and manufacturing of the cameras and reducing the associated costs. The lateral point cloud resolution of the disclosed cameras can be equal to the pixel resolution of the used CMOS/CCD chip—e.g., up to 20 Mp and beyond, given the current state of the art in CMOS camera technology. These capabilities provide significant advantages for the disclosed camera devices with respect to the current state of the art ToF cameras and allow for many high-precision 3D and other imaging applications that were previously not possible.

In some embodiment, the disclosed technology leverages and improves upon Synthetic Wavelength Interferometry (SWI), a method for multifrequency interferometry. SWI exploits the spectral diversity of multiple measurements at multiple wavelengths to image objects with optically rough surfaces. The basic principle is summarized as follows: An optically rough surface is illuminated with coherent light (at wavelength λ₁), and the complex field E(λ₁) scattered off the object's surface is measured using an optical interferometer. This field exhibits strong wavefront aberrations due to speckle. Optical pathlength information (i.e., the shape of the object) cannot be recovered from E(λ₁). Eventually, the static object is again illuminated with a slightly different wavelength λ₂, and a new field E(λ₂) is obtained. Assuming both illumination sources originate from the exact same location (e.g., the same fiber tip), the fields E(λ₁) and E(λ₁) are subject to the same microscopic and macroscopic optical pathlength variations. After calculating the difference between their phasemaps, φ(λ₁)-φ(λ₂), the phase aberrations imparted by the microscopic pathlength variations cancel each other out, and the phasemap difference only contains the macroscopic pathlength variations on the order of a “Synthetic Wavelength,”

$$Λ = \frac{{λ}_{1} {λ}_{2}}{\vert {λ}_{1} - {λ}_{2} \vert} .$$

If λ₁ and λ₂ are spaced close enough, the resulting “synthetic field,” E(Λ), does not exhibit speckle artifacts and can be processed like a “normal” ToF camera image or optical interferogram. This means that the object depth can be calculated by:

$$z = \frac{1}{2} \frac{ϕ ( Λ ) \cdot Λ}{2 π} . \qquad ( 1 )$$

One possible way to calculate the synthetic field E(Λ) is computational mixing of E(Λ) and E(λ₁):

$$E ( Λ ) = E ( {λ}_{1} ) \cdot {E}^{*} ( {λ}_{2} ) = \vert E ( {λ}_{1} ) \vert \cdot \vert E ( {λ}_{2} ) \vert \cdot {e}^{i ( ϕ ( {λ}_{1} ) - ϕ ( {λ}_{2} ) )} = \vert E ( {λ}_{1} ) \vert \cdot \vert E ( {λ}_{2} ) \vert \cdot {e}^{i ϕ ( Λ )} \qquad ( 2 )$$

where E*(λ₂) denotes the complex conjugate of E(λ₂).

The above technique requires at least two sequentially captured camera images to reconstruct the object's depth maps. One would capture the field E(λ₁) and then repeat the measurement using a different wavelength to obtain E(λ₁). This approach works for static scenes but completely fails for dynamic scenes: If the object moves between the two sequential images, the optical pathlength between both images will differ, and the correlation between both speckle fields, needed to calculate the synthetic wavelength term, is lost. It turns out that this problem is much more severe than “conventional” motion artifacts (e.g., in structured light principles) as very small object movements can induce large changes in the observed speckle patterns. This presents a severe drawback, as many real-world applications include scenes that naturally move at least on a microscopic scale (e.g., in medical imaging, autonomous driving, or AR/VR). This problem is further exacerbated in applications where both the object of interest and the intervening media are in motion.

The disclosed technology overcomes these problems by, among other operations, conducting a single shot measurement and leveraging the specific procedures describe herein to obtain improved images.

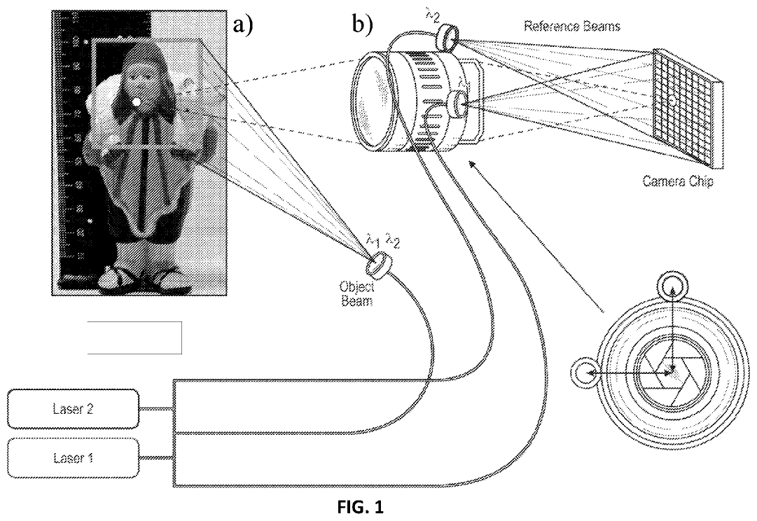

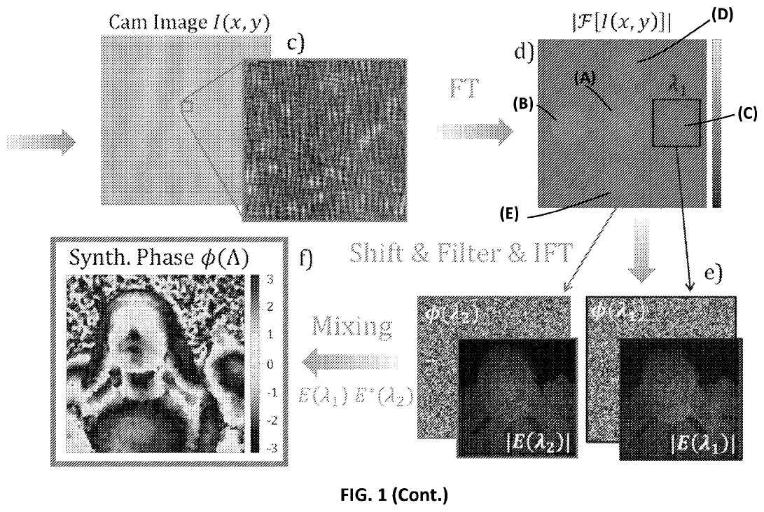

FIG. 1 illustrates a diagram of a single shot ToF camera system and associated processing in accordance with an example embodiment. As shown in panel (a), the laser beams at two different wavelengths, λ₁ and λ₂, are coupled together, forming the object beam that illuminates the object. Panel (a) illustrates that the area around the head and shoulders of the object are illuminated. In panel (b), each of the two laser beams (having wavelengths λ₁ and λ₂) form a corresponding reference beam that directly illuminates the detector (e.g., CCD camera chip) at a particular angle. In the depicted example, one reference beam (e.g., λ₁) encloses an angle with the horizontal x-axis, while the other reference beam (e.g., λ₂) encloses an angle with the vertical y-axis of the detector. The camera lens images the scene onto the detector (camera chip).

When the object beam is scattered off the object surface, it forms a speckle field at each wavelength: E(λ₁) and E(λ₁). These two speckle fields are incident on the detector and interfere with the reference beams. The speckle field at λ₁ produces a static interference pattern with the λ₁-reference beam (in this example, vertical fringes), while the speckle field at λ₂, produces a static interference pattern with the λ₂-reference beam (in this example, horizontal fringes). The camera image, I(x,y), shows speckles that are overlayed by crossed fringes. Panel (c) shows the camera image, and a zoomed-in section that exhibits a cross-hatched pattern. For the sake of completeness, it should be mentioned that interference also happens between the fields at λ₁ and λ₂. These interferences result in temporally oscillating fringes which oscillate much faster than the integration time of our used camera and hence are not further discussed here.

After acquiring the Image I(x,y), in single-shot, the complex speckle fields (phase and amplitude) E(λ₁) and E(λ₂) required to form the synthetic field E(Λ)=E(λ₁)·E*(λ₂) are retrieved via computational demodulation in the Fourier domain. Panel (d) in FIG. 1 illustrates the 2D Fourier transform of the captured image, F[I(x,y)], where five spectral regions with high intensity can be distinguished: The central region (A) represents the DC component. The horizontal regions (left (B) and right (C)) are centered around the spatial carrier frequencies of the vertical fringes, which appear due to the interferences between the λ₂-reference beam and the object field E(λ₁). Similarly, the vertical regions (up (D) and down (E)) are centered around the carrier frequencies for the horizontal fringes produced by the reference and object field at λ₂.

The complex field E(λ₁) is retrieved by, for example, finding the carrier frequency, f₁, for the respective spectrum in the Fourier domain (box around (C) in panel (d)), then shifting the Fourier spectrum to set the evaluated carrier frequency, f₁, as new center frequency. Then the spectrum is filtered (e.g., with a Hanning window or Gaussian kernel) so that only the frequency band around the new center frequency remains. The resulting filtered spectrum can be denoted by Fₕₒᵣ[I(x,y)]. Next, an inverse Fourier transform (IFT) of Fₕₒᵣ[I(x,y)] eventually delivers the phase φ(λ₁) and amplitude E(λ₁) of the complex field E(λ₁) (see panel (e) in FIG. 1):

$${F}^{- 1} \{ {F}_{h o r} [ I ( x , y ) ] \} ∝ \vert E ( x , y ; {λ}_{1} ) \vert exp ( i ϕ ( x , y ; {λ}_{1} ) ) \qquad ( 3 )$$

The complex field E(λ₂) is retrieved from the same image in as similar fashion as above, using the vertically arranged regions in the Fourier spectrum. Eventually, the synthetic field E(Λ) is formed via Eq. 2, the synthetic phase φ(Λ) is extracted, and the depth map of the object is calculated via Eq. 1.

It should be noted that while in the example configuration in FIG. 1 (and specifically, panel (b)) illustrates the two reference beams are aligned along the x and y-axis, respectively, in other configurations, the reference beams can be positioned along a single axis albeit at different angles. In general, the reference beams can be positioned to illuminate the detector such that the Fourier transform of the captured image (combination of object and reference beams) includes spectrally separated regions (without overlap) to allow the complex field complex field, E(λ₁), to be extracted for each λ. For example, in some configurations the two reference beams are positioned in the same plane but are incident at the detector at different angles. In another configuration, the two reference beams are in different planes but are incident at the detector at different or same angles. In this context, a plane can be defined using three points: (A) origin of the respective reference beam (fiber tip in the above example configuration), (B) a point where the optical axis intersects the imaging lens (e.g., the center of the imaging lens in most cases), and (C) a point where the optical axis intersects the sensor chip (e.g., the center of the chip in most cases).

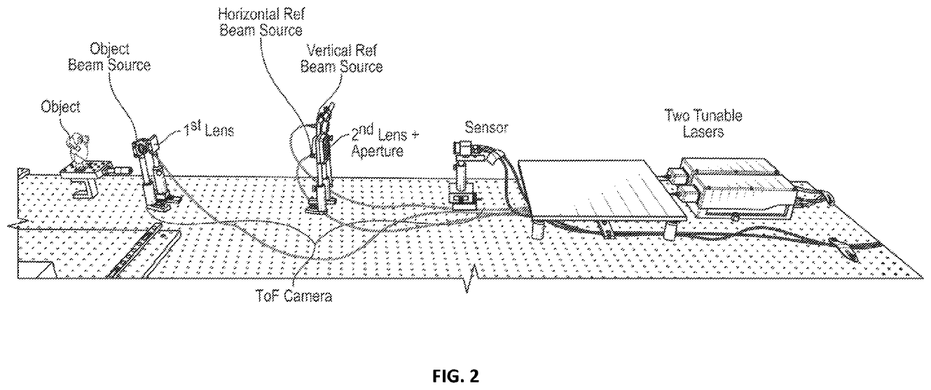

FIG. 2 illustrates a benchtop experimental setup of an optical system in accordance with an example embodiment. The optical system includes two tunable lasers (Toptica DFB pro devices) that are combined to illuminate the object; each laser output also separately illuminates the sensor (reference beam). In particular, the light emitted from each laser is separated into the object and reference arms using a fiber splitter, where 90% of the power goes to the object and 10% to the reference. In addition, the two object arms are combined so that the resulting object source contains both wavelengths, λ₁ and λ₂. For experimental purposes, both wavelengths were in the NIR range at around 850 nm. We used optical fibers and beam splitters (BS) to direct the beams flexibly.

The system in FIG. 2 is a 4f-system and includes a lens system, comprising a first lens and a second lens plus an aperture. The lens system focuses the imaged object onto the camera chip. In order to incorporate the reference arms, it is required to leave a few centimeters between the sensor chip and its closest lens. This increases the back focal length of the system, affecting the field of view (FoV) of the camera and making this example optical prototype system less compact.

It should be also mentioned that multiple possible setup configurations exist. As mentioned before and illustrated in FIG. 2, we used a reference source aligned on the horizontal axis and another on the vertical axis (see attachments to the aperture and labels “Vertical ref beam source” and “Horizontal ref beam source”). However, other spatially separated reference beams are possible as well. For instance, two reference beams can be placed along one single axis enclosing different angles.

Although the object beam has much more intensity than the two reference beams, we must consider that the light which is scattered off the object surface and passes through the optical system is considerably less intense than the initial object beam. We used neutral density (ND) filters on the reference beams to match the intensity that reaches the sensor from the references and the object beam. When they match, the interference fringes have maximum contrast: destructive interferences with almost zero intensity and constructive fringes with four times the intensity of each beam.

Additionally, we placed an iris at the objective lens to control the size of the subjective speckles at the sensor location. This is needed because our method requires several interference fringes within one speckle, which means that the speckle size needs to be controlled by the iris.

It should be further noted that, while in the above description, two laser beams (at two different wavelengths) have been described, in some embodiments more than two laser beams can be used. For example, in some example embodiments, three wavelengths can be combined to illuminate the object, and three reference beams can be positioned to illuminate the detector directly. For instance, the three reference beams can be separated by 60° around the aperture (instead of 90° as was illustrated for 2 wavelengths). In this scenario, the transform domain signal can include another pair of maxima that can be isolated and demodulated. As a result, three optical fields at three different optical wavelengths are obtained that are subsequently combined to two different synthetic fields at two different synthetic wavelengths. This allows to perform multi-frequency phase unwrapping in only one shot. This scenario can be generalized to more than three wavelengths.

### Example Acquisition Results

In the following, we use our described setup prototype to capture 3D images and 3D videos of different objects, using different single-shot and double-shot acquisition modes.

Double-Shot Acquisition: The “double-shot” acquisition mode still captures the fields E(λ₁) and E(λ₁) at both optical wavelengths sequentially. This means that only one reference arm and only one direction in the Fourier spectrum is exploited, and two camera images are required to calculate the synthetic field E(Λ) (hence the word “double-shot”). However, it should be emphasized that each optical field E(λ₁) or E(λ₁) itself is acquired in single shot, which is in stark contrast to conventional interferometry that normally relies on phase shifting and multiple exposures to capture the optical field.

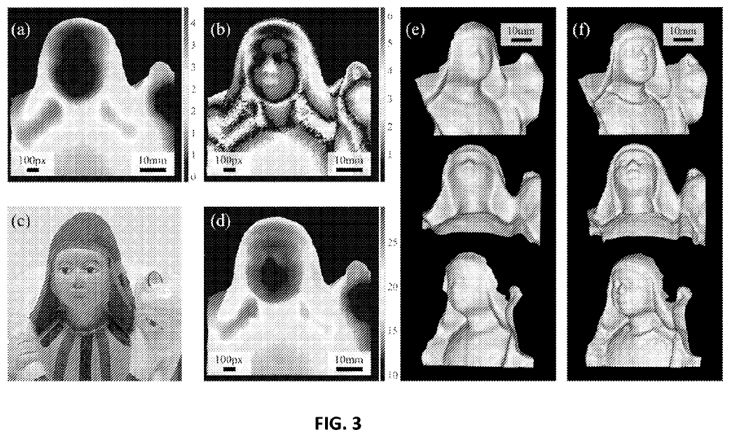

FIG. 3 shows first double-shot acquisition results. The object was a painted clay figure of approximately 10 cm in height and the field of view was 66×66 mm². Image of the object, cropped to the actual FoV, is shown in panel (c). The synthetic phasemap shown in panel (a) was acquired at a synthetic wavelength Λ=45 mm and the calculated 3D model is shown in panel (e). Measurements at smaller synthetic wavelengths yield higher depth precision. However, for measurements at synthetic wavelengths Λ smaller than 2× the object depth, the reconstructed synthetic phasemaps observe phase wrapping. To solve this problem, we applied a multi-frequency unwrapping algorithm that allows us to recover unwrapped phasemaps at small synthetic wavelength using only a set of wrapped phasemaps at different synthetic wavelengths. An example procedure is as follows: from two synthetic fields E(Λ₁) and E(Λ₂) with wrapped phasemaps, we calculate the beat-note field E(AB)=E(Λ₁)·E*(Λ₂), which can be also seen as the “synthetic-synthetic field.” If E(Λ₁) and E(Λ₂) are chosen correctly, the respective phasemap φ(Λ_{B}) is not wrapped and can be used as a guidance to unwrap fields at smaller synthetic wavelengths via the standard phase unwrapping procedure. Of course, this requires the acquisition of additional optical fields E(λ₁) to form multiple synthetic fields at different synthetic wavelengths.

FIG. 3, in panel (b), displays a wrapped synthetic phasemap of the object acquired at a synthetic wavelength of Λ=10 mm. Panel (d) shows the same phasemap, unwrapped with the procedure described above. The respective rendered 3D model is shown in panel (f). As expected, the 3D data display much higher depth resolution and details of the object surface. Fine details like the eyes or nose of the figure can be resolved with impressive quality (see scalebar for size comparison). It should be also mentioned that different smoothing operations are applied after each unwrapping step to facilitate “smoother” guidance phasemaps.

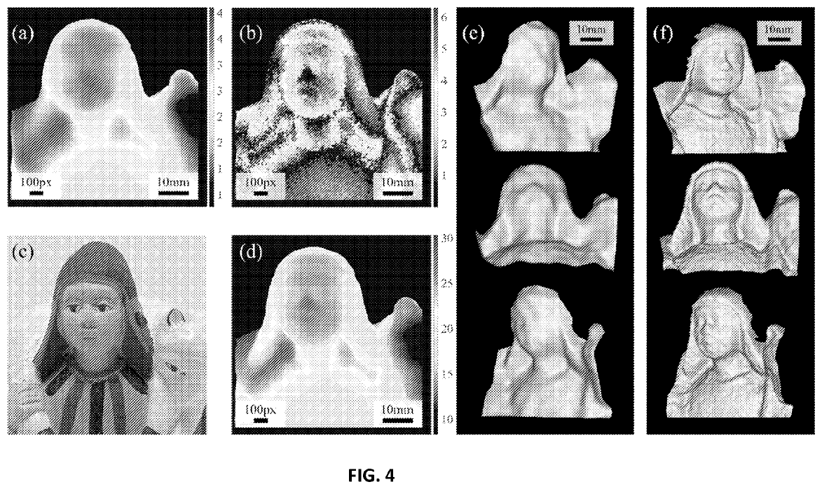

Single-shot Acquisition: The “single-shot” acquisition mode captures the synthetic field E(Λ) with only one camera image, using the full Fourier demodulation procedure (with two reference beams) described earlier. The results in FIG. 4 are intentionally presented in an analog fashion to FIG. 3 to allow for the comparison of both acquisition modes.

Panel (a) in FIG. 4 shows a single-shot phasemap captured at a synthetic wavelength of Λ=50 mm-large enough that the phasemap is “unique,” i.e., not subject to phase wrapping. The respective 3D model is shown in panel (e). Panel (b) in FIG. 4 shows a wrapped single-shot phasemap captured at Λ=10 mm. The same phasemap processed with the unwrapping procedure described above is displayed in panel (d), and the respective 3D model is shown in panel (f).

It can be seen that the quality and detail richness of the measurement does not significantly decrease for the “single-shot” compared to the previously shown “double-shot” method. For a quantitative depth precision evaluation of our camera and a comparison between single-shot and double-shot acquisition, we evaluated single-shot and double-shot measurements of a planar surface (cardboard) at different synthetic wavelengths. A small region of the cardboard (roughly 23×23 mm²) was picked for evaluation. After subtraction of a best-fit plane, the standard deviation of the (unfiltered) point cloud was calculated. This value represents the depth precision δz of the respective measurement. The results are displayed in Table 1, which illustrates that the single-shot measurements achieve roughly the same depth precision than their double-shot counterparts at the same synthetic wavelength. For Λ≤3 mm, our camera achieves sub-mm precision with a best reported precision of only δz_{single}=330 μm for Λ=1 mm, which outperforms the precision of conventional ToF cameras roughly by a factor of 100×.

TABLE 1
Depth precision analysis comparing the double-
shot with the single-shot method.

| ∧ [mm] | 40 | 10 | 5 | 3 | 1 |
|---|---|---|---|---|---|
| δz_{double} [mm] | 5.30 | 1.95 | 1.14 | 0.82 | 0.43 |
| δz_{single} [mm] | 5.56 | 1.78 | 1.64 | 0.79 | 0.33 |

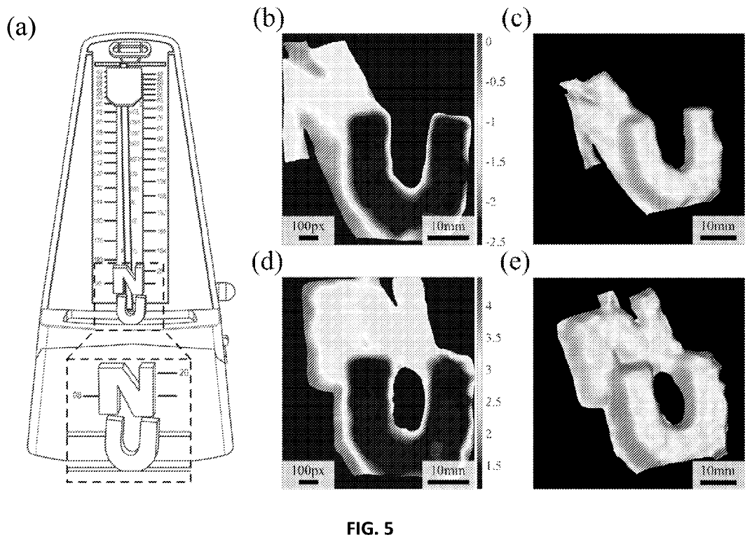

To further demonstrate the single-shot capability of the disclosed Synthetic Wavelength Interferometry (SWI) ToF camera, we recorded a 3D video of a moving object. Each video frame consisted of a single-shot measurement of the object at a synthetic wavelength of Λ=30 mm. The object was a metronome whose pendulum moved left-to-right and then back right-to-left with multiple oscillations. To make the movement more obvious, two letters were attached to the metronome-one letter at the pendulum and one letter at the metronome body (see FIG. 5, panel (a), further described below). During oscillation, the back letter moved laterally with respect to front letter.

FIG. 5 illustrates example single-shot measurements of a dynamic object. In panels (b) and (d) two synthetic phasemaps (φ(Λ=30 mm)) from two different time instances of the video are shown. The respective 3D reconstructions are shown in panels (c) and (e). We emphasize again that such a 3D video sequence would not have been possible with prior systems.

### Single-Shot NLOS Imaging Through Scattering Scenes

In describing the example embodiments up to this point, we have explained the so-called Line-of-Sight (LoS) measurements, where the object is directly visible and can be directly imaged onto the sensor. However, the same sensor techniques can be used to image objects which are hidden from direct view, e.g., behind a scattering medium or around a corner. These so-called “Non-Line-of-Sight” (NLoS) measurements are useful for many applications, such as autonomous driving, medical diagnosis, quality inspection of manufacturing products, and others. For instance, we could think of an imaging system that could see through fog, that could see through the human tissue to observe the inner organs, or could look “around corners” to see some industrial machinery in operations.

We have established that the single-shot ability of our camera is particularly crucial for NLOS measurements-even if the hidden object does not move. The reason is that most scattering media, such as fog, smoke, turbid water, or even human tissue are in constant microscopic motion. For the double-shot method, this would lead to the already discussed decorrelation of speckle patterns which would result in a complete loss of information.

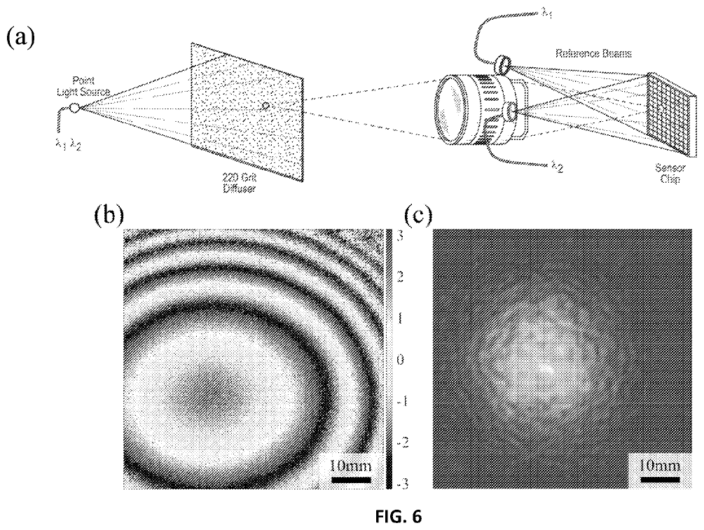

FIG. 6 illustrates a single-shot NLOS system and the associated measurements through a scattering scene in accordance with an example embodiment. As shown in panel (a), the object behind the scatterer is a simple point light source (fiber tip), which emits light at both optical wavelengths λ₁ and λ₂. The scatterer is a 220-grit ground glass diffuser. The synthetic phasemap φ(Λ) (see panel (b)) is captured at the diffuser surface and the related field is computationally backpropagated at the synthetic wavelength to reconstruct the point source in the hidden volume behind the diffuser. An image of the reconstructed point light source is shown in panel (c). The diameter of the bright spot in the middle roughly matches the theoretical expectations about the reconstruction resolution of the point light source.

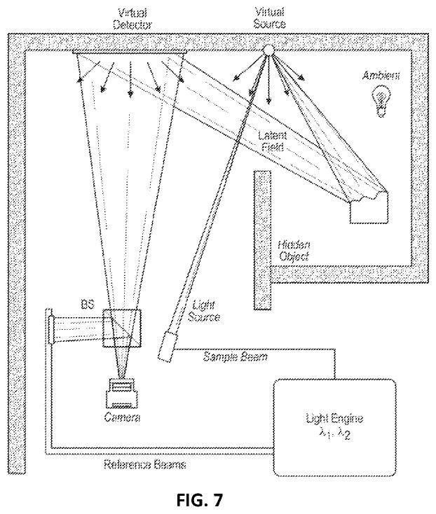

The disclosed embodiments can be similarly applied for imaging applications, where a direct line of sight to an object is obstructed, and the imaging apparatus relies on indirect (e.g., reflected or scattered) beams that are received at the detector. This technique is sometimes referred to as synthetic wavelength holography (SWH). FIG. 7 illustrates an example configuration where a hidden object can be detected using the disclosed techniques. The object is located in an obstructed section of a room with no direct line of sight to the detector. In this configuration, the laser beam comprising the two spectral wavelengths is positioned to illuminate the object indirectly after being reflected from a section of the wall (a virtual source). The object beam reaches the detector after reflection(s) from another section of the wall (virtual detector). The two reference beams are positioned to illuminate the detector directly as described in connection with earlier figures. Accordingly, the synthetic field, synthetic phase, a 2D image and/or a depth profile of the object can be determined as previously described.

Benefits and Advantages: Some of the benefits of SWH over the traditional ToF imaging are described below.

Small Probing Area: Many ToF-based schemes require large probing areas of ˜1 m×1 m or larger, which limits their ability to detect hidden objects in confined spaces. SWH provides the ability to image obscured objects by simultaneously illuminating and observing a small area.

Wide Angular Field of View: Angular memory effect-based approaches are limited to highly restricted fields of view. As a holographic method, SWH provides the ability to recover obscured objects over a nearly hemispherical field of view that far exceeds the limited angular extent of the memory effect.

High Spatial Resolution: ToF camera-based approaches generally produce rather low spatial resolutions, due to the used intensity-modulated waves with long wavelengths. SWH allows for freely tunable synthetic wavelengths and provides the ability to resolve small features on obscured objects.

High Temporal Resolution: Many approaches rely on point-wise raster-scanning and/or the acquisition of a temporal image sequence. SWH can recover full field holograms of the obscured object using off-the-shelf camera technology, which makes the method already faster than many of its competitors. However, it has been discussed above that the SWH dual-shot solution is still not sufficient to image through dynamic scattering media, like living tissue or fog.

It is evident that the disclosed embodiments provide many benefits and advantages over the existing state of the art systems. In particular, while the standard (single-wavelength) interferometric ToF cameras are limited to specular objects, the disclosed systems and methods can image objects with optically rough surfaces. Existing multifrequency interferometric ToF cameras for Computer Vision applications are limited to static objects and/or used exotic sensors (e.g., PMDs, SPADs, or lock-in detectors)). In contrast, the disclosed methods and systems enable high-precision measurements with conventional CCD/CMOS sensors, which reduces the cost of manufacturing and simplifies the design of the system. The disclosed embodiments thus allow capturing of videos of moving objects and reconstruction of the dynamic 3D model at high precision. Moreover, we have demonstrated a depth precision of up to 330 μm-roughly 100× better than the precision of conventional ToF cameras. The disclosed techniques have great potential and utility for high-precision applications with dynamic object movement that include, but are not limited to, augmented reality/virtual reality (AR/VR), industrial inspection, medical imaging and imaging through scattering media like fog or human tissue.

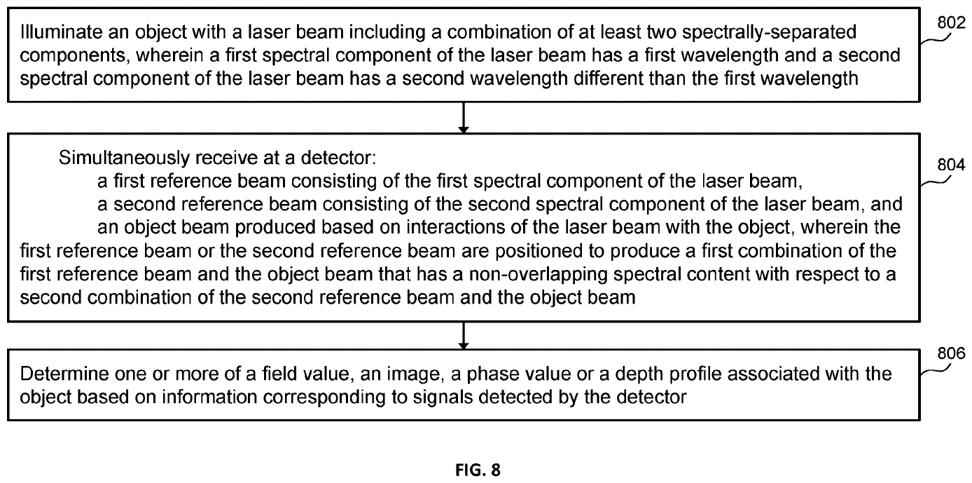

FIG. 8 illustrates a set of operations that can be carried out for time-of-flight sensing in accordance with an example embodiment. At 802, an object is illuminated with a laser beam including a combination of at least two spectrally-separated components. A first spectral component of the laser beam has a first wavelength and a second spectral component of the laser beam has a second wavelength different than the first wavelength. At 804, a detector simultaneously receives: a first reference beam consisting of the first spectral component of the laser beam, a second reference beam consisting of the second spectral component of the laser beam, and an object beam produced based on interactions of the laser beam with the object. The first reference beam or the second reference beam are positioned to produce a first combination of the first reference beam and the object beam that has a non-overlapping spectral content with respect to a second combination of the second reference beam and the object beam. At 806, one or more of a field value, an image, a phase value or a depth profile associated with the object is determined based on information corresponding to signals detected by the detector.

In one example embodiment, the non-overlapping spectral contents of the first and the second combinations are in a Fourier transform domain. In another example embodiment, the first combination includes fringes that are oriented along a first axis, and the second combination includes fringes that are oriented along a second axis. In yet another example embodiment, the first axis and the second axis are orthogonal to each other. In still another example embodiment, the first and the second reference beams are positioned to illuminate the detector directly at two different angles.

According to another example embodiment, the first and the second reference beams are positioned along different axis to illuminate the detector directly at the same or at different angles. In one example embodiment, the information corresponding to the signals detected by the detector includes detected intensity values associated with an image formed on the detector, and determining the one or more of the field value, the image, the phase value or the depth profile associated with the object includes: performing a Fourier transform, and for spectral contents associated with the first combination: isolating a region of the spectral contents, and determining one or more complex field values, including one or more of a phase and a magnitude, associated with scattered light from the object responsive to the first spectral component. For spectral contents associated with the second combination: isolating a region of the spectral contents, and determining one or more a complex field values, including one or more of a phase and a magnitude, associated with scattered light from the object responsive to the second spectral component, and determining a synthetic field that is a function of both the first spectral component and the second spectral component.

In another example embodiment, the first spectral component is represented by λ1, the second spectral component is represented by λ2, and the synthetic field is a function of a synthetic wavelength represented by (λ_1 λ_2)/|λ_1−λ_2|. In yet another example embodiment, the above noted method further includes determining the depth profile associated with the object based on the synthetic wavelength and a phase of the synthetic field.

In one example embodiment, the object is located behind a scattering medium, and the object beam is further subject to interactions with the scattering medium. In another example embodiment, the object is not within a line of sight of the detector, and the object beam is further subject to interactions with one or more reflecting or scattering surfaces prior to, or after, interactions with the object. In still another example embodiment, the above noted method includes determining one or more of the field value, the image, the phase value or the depth profile associated with the object based on the information corresponding to the signals detected by the detector for multiple time instances. In one example embodiment, the information corresponding to the signals detected by the detector for multiple time instances enables an assessment or mitigation of (a) a motion in the object, (b) in a medium that interferes with direct viewing of the object, or both.

In yet another example embodiment, the laser beam includes more than two spectrally-separated components, the detector is simultaneously illuminated with the object beam and more than two reference beams, each reference beam consisting of one of the spectrally-separated components, and each combination of the object beam and one of the reference beams has a spectrally non-overlapping region with the combination of the object beam and any other reference beam.

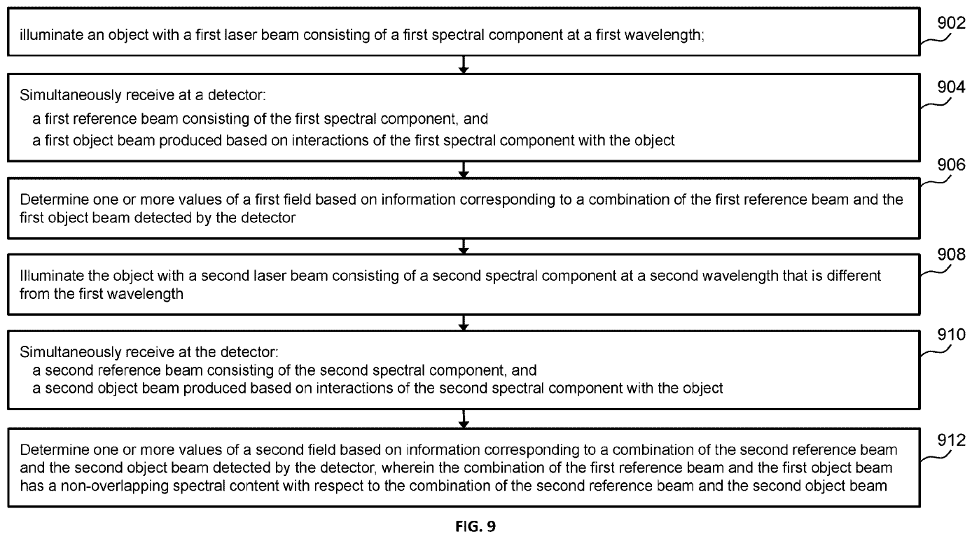

FIG. 9 illustrates a set of operations that can be carried out for time-of-flight sensing in accordance with another example embodiment. At 902, an object is illuminated with a first laser beam consisting of a first spectral component at a first wavelength. At 904, a detector simultaneously receives: a first reference beam consisting of the first spectral component, and a first object beam produced based on interactions of the first spectral component with the object. At 906, one or more values of a first field are determined based on information corresponding to a combination of the first reference beam and the first object beam detected by the detector. At 908, the object is illuminated with a second laser beam consisting of a second spectral component at a second wavelength that is different from the first wavelength. At 910, the detector simultaneously receives: a second reference beam consisting of the second spectral component, and a second object beam produced based on interactions of the second spectral component with the object. At 912, one or more values of a second field are determined based on information corresponding to a combination of the second reference beam and the second object beam detected by the detector. The combination of the first reference beam and the first object beam has a non-overlapping spectral content with respect to the combination of the second reference beam and the second object beam.

In one example embodiment that above noted operations further include determining one or more of an image, a phase value or a depth profile associated with the object.

Another aspect of the disclosed embodiments relates to a ToF camera system that includes one or more light sources configured to produce a first laser beam having at least a first spectral component and a second laser beam having a second spectral component that is different from the first spectral component, wherein the one or more light sources are configured to illuminate an object with a combined laser beam including both the first laser beam and the second laser beam. The ToF system further includes one or more lenses configured to image the object onto a detector. The detector is positioned to simultaneously receive: a first reference beam consisting of the first laser beam, a second reference beam consisting of the second laser beam, and an object beam produced in response to illumination of the object by the combined laser beam. The one or more lenses are configured to provide the object beam to the detector. In this system, the first reference beam and the second reference beam are configured to directly illuminate the detector and to produce a first combination of the first reference beam and the object beam that has a non-overlapping spectral content with respect to a second combination of the second reference beam and the object beam, and information corresponding to signals detected by the detector enables determination of one or more of a field value, an image, a phase value or a depth profile associated with the object.

The ToF camera system, in some embodiment, further includes a processor and a memory including instruction stored thereon, wherein the instructions upon execution by the processor cause the processor to determine one or more of the field value, the image, the phase value or the depth profile associated with the object. In one example embodiment, the non-overlapping spectral contents of the first and the second combinations are in a Fourier transform domain. In another example embodiment, the first and the second reference beams are positioned to illuminate the detector directly at two different angles. In yet another example embodiment, the first and the second reference beams are positioned along different axis to illuminate the detector directly at the same or at different angles.

According to another example embodiment, the information corresponding to signals detected by the detector includes detected intensity values associated with an image formed on the detector. In this example embodiment, the instructions upon execution by the processor cause the processor to determine the one or more of the field value, the image, the phase value or the depth profile associated with the object by operations that include: performing a Fourier transform, for spectral contents associated with the first combination: isolating a region of the spectral contents, and determining one or more complex field values, including one or more of a phase and a magnitude, associated with scattered light from the object responsive to the first spectral component. For spectral contents associated with the second combination: isolating a region of the spectral contents, and determining one or more complex field values, including one or more of a phase and a magnitude, associated with scattered light from the object responsive to the second spectral component, and determining a synthetic field that is a function of both the first spectral component and the second spectral component.

In one example embodiment of the ToF camera system, the first spectral component is represented by λ1, the second spectral component is represented by λ2, and the synthetic field is a function of a synthetic wavelength represented by (λ_1 λ_2)/|λ_1−λ_2|. In another example embodiment, the instructions upon execution by the processor further cause the processor to determine the depth profile associated with the object based on the synthetic wavelength and a phase of the synthetic field. In still another example embodiment, the ToF camera system includes a beam combiner positioned to receive the first and the second laser beams. In yet another example embodiment, the detector is one of a complementary metal oxide semiconductor (CMOS) or a charge coupled device (CCD). In one example embodiment, the ToF camera system is implemented using a mobile phone, and the detector is the mobile phone's detector.

According to another example embodiment, the one or more light sources are configured to produce the laser beam that includes more than two spectrally-separated components, the detector is positioned to simultaneously receive the object beam and more than two reference beams, each reference beam consisting of one of the spectrally-separated components, and each combination of the object beam and one of the reference beam has a spectrally non-overlapping region with the combination of the object beam and any other reference beam.

It is understood that the various disclosed embodiments may be implemented individually, or collectively, in devices comprised of various optical components, electronics hardware and/or software modules and components. One example device can comprise at least one processor and/or controller, at least one memory unit that is in communication with the processor, and at least one communication unit that enables the exchange of data and information, directly or indirectly, through the communication link with other entities, devices, databases and networks. The communication unit may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The device may be integrated as part of any disclosed devices or components to carry out any of the disclosed methods, to carry out various computations, or to control the operation of various components disclosed herein.

Various information and data processing operations described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

1. A method for time-of-flight sensing, comprising:
illuminating an object with a laser beam including a combination of at least two spectrally-separated components, wherein a first spectral component of the laser beam has a first wavelength and a second spectral component of the laser beam has a second wavelength different than the first wavelength;
simultaneously receiving at a detector:
a first reference beam consisting of the first spectral component of the laser beam,
a second reference beam consisting of the second spectral component of the laser beam, and
an object beam produced based on interactions of the laser beam with the object, wherein:
the first reference beam or the second reference beam are positioned to produce a first combination of the first reference beam and the object beam that has a non-overlapping spectral content with respect to a second combination of the second reference beam and the object beam; and
determining one or more of a field value, an image, a phase value or a depth profile associated with the object based on information corresponding to signals detected by the detector.

2. The method of claim 1, wherein the non-overlapping spectral contents of the first and the second combinations are in a Fourier transform domain.

3. The method of claim 1, wherein the first combination includes fringes that are oriented along a first axis, and the second combination includes fringes that are oriented along a second axis.

4. The method of claim 3, wherein the first axis and the second axis are orthogonal to each other.

5. The method of claim 1, wherein the first and the second reference beams are positioned to illuminate the detector directly at two different angles.

6. The method of claim 1, wherein the first and the second reference beams are positioned along different axis to illuminate the detector directly at the same or at different angles.

7. The method of claim 1, wherein the information corresponding to the signals detected by the detector includes detected intensity values associated with an image formed on the detector, and determining the one or more of the field value, the image, the phase value or the depth profile associated with the object includes:
performing a Fourier transform,
for spectral contents associated with the first combination:
isolating a region of the spectral contents, and
determining one or more complex field values, including one or more of a phase and a magnitude, associated with scattered light from the object responsive to the first spectral component,
for spectral contents associated with the second combination:
isolating a region of the spectral contents, and
determining one or more a complex field values, including one or more of a phase and a magnitude, associated with scattered light from the object responsive to the second spectral component, and
determining a synthetic field that is a function of both the first spectral component and the second spectral component.

8. The method of claim 7, wherein the first spectral component is represented by λ₁, the second spectral component is represented by λ₂, and the synthetic field is a function of a synthetic wavelength represented by
$$\frac{{λ}_{1} {λ}_{2}}{\vert {λ}_{1} - {λ}_{2} \vert} .$$

9. The method of claim 8, further comprising determining the depth profile associated with the object based on the synthetic wavelength and a phase of the synthetic field.

10. The method of claim 1, wherein the object is located behind a scattering medium, and the object beam is further subject to interactions with the scattering medium.

11. The method of claim 1, wherein the object is not within a line of sight of the detector, and the object beam is further subject to interactions with one or more reflecting or scattering surfaces prior to, or after, interactions with the object.

12. The method of claim 1, comprising determining one or more of the field value, the image, the phase value or the depth profile associated with the object based on the information corresponding to the signals detected by the detector for multiple time instances.

13. The method of claim 12, wherein the information corresponding to the signals detected by the detector for multiple time instances enables an assessment or mitigation of (a) a motion in the object, (b) in a medium that interferes with direct viewing of the object, or both.

14. The method of claim 1, wherein:
the laser beam includes more than two spectrally-separated components,
the detector is simultaneously illuminated with the object beam and more than two reference beams, each reference beam consisting of one of the spectrally-separated components, and
each combination of the object beam and one of the reference beams has a spectrally non-overlapping region with the combination of the object beam and any other reference beam.

15. A time-of-flight (ToF) camera system, comprising:
one or more light sources configured to produce a first laser beam having at least a first spectral component and a second laser beam having a second spectral component that is different from the first spectral component, wherein the one or more light sources are configured to illuminate an object with a combined laser beam including both the first laser beam and the second laser beam; and
one or more lenses configured to image the object onto a detector;
the detector positioned to simultaneously receive:
a first reference beam consisting of the first laser beam,
a second reference beam consisting of the second laser beam, and
an object beam produced in response to illumination of the object by the combined laser beam, the one or more lenses configured to provide the object beam to the detector, wherein:
the first reference beam and the second reference beam are configured to directly illuminate the detector and to produce a first combination of the first reference beam and the object beam that has a non-overlapping spectral content with respect to a second combination of the second reference beam and the object beam, and
information corresponding to signals detected by the detector enables determination of one or more of a field value, an image, a phase value or a depth profile associated with the object.

16. The ToF camera system of claim 15, comprising a processor and a memory including instruction stored thereon, wherein the instructions upon execution by the processor cause the processor to determine one or more of the field value, the image, the phase value or the depth profile associated with the object.

17. The ToF camera system of claim 15, wherein the non-overlapping spectral contents of the first and the second combinations are in a Fourier transform domain.

18. The ToF camera system of claim 15, wherein the first and the second reference beams are positioned to illuminate the detector directly at two different angles.

19. The ToF camera system of claim 15, wherein the first and the second reference beams are positioned along different axis to illuminate the detector directly at the same or at different angles.

20. The ToF camera system of claim 16, wherein the information corresponding to signals detected by the detector includes detected intensity values associated with an image formed on the detector, and the instructions upon execution by the processor cause the processor to determine the one or more of the field value, the image, the phase value or the depth profile associated with the object by operations that include:
performing a Fourier transform,
for spectral contents associated with the first combination:
isolating a region of the spectral contents, and
determining one or more complex field values, including one or more of a phase and a magnitude, associated with scattered light from the object responsive to the first spectral component,
for spectral contents associated with the second combination:
isolating a region of the spectral contents, and
determining one or more complex field values, including one or more of a phase and a magnitude, associated with scattered light from the object responsive to the second spectral component, and
determining a synthetic field that is a function of both the first spectral component and the second spectral component.

21. The ToF camera system of claim 20, wherein the first spectral component is represented by λ₁, the second spectral component is represented by λ₂, and the synthetic field is a function of a synthetic wavelength represented by
$$\frac{{λ}_{1} {λ}_{2}}{\vert {λ}_{1} - {λ}_{2} \vert} .$$

22. The ToF camera system of claim 21, wherein the instructions upon execution by the processor further cause the processor to determine the depth profile associated with the object based on the synthetic wavelength and a phase of the synthetic field.

23. The ToF camera system of claim 15, comprising a beam combiner positioned to receive the first and the second laser beams.

24. The ToF camera system of claim 15, wherein the detector is one of a complementary metal oxide semiconductor (CMOS) or a charge coupled device (CCD).

25. The ToF camera system of claim 15, wherein the ToF camera system is implemented using a mobile phone, and the detector is the mobile phone's detector.

26. The ToF camera system of claim 15, wherein
the one or more light sources are configured to produce the laser beam that includes more than two spectrally-separated components,
the detector is positioned to simultaneously receive the object beam and more than two reference beams, each reference beam consisting of one of the spectrally-separated components, and
each combination of the object beam and one of the reference beam has a spectrally non-overlapping region with the combination of the object beam and any other reference beam.

27. A method for time-of-flight sensing, comprising:
illuminating an object with a first laser beam consisting of a first spectral component at a first wavelength;
simultaneously receiving at a detector:
a first reference beam consisting of the first spectral component, and
a first object beam produced based on interactions of the first spectral component with the object;
determining one or more values of a first field based on information corresponding to a combination of the first reference beam and the first object beam detected by the detector;
illuminating the object with a second laser beam consisting of a second spectral component at a second wavelength that is different from the first wavelength;
simultaneously receiving at the detector:
a second reference beam consisting of the second spectral component, and
a second object beam produced based on interactions of the second spectral component with the object; and
determining one or more values of a second field based on information corresponding to a combination of the second reference beam and the second object beam detected by the detector; wherein:
the combination of the first reference beam and the first object beam has a non-overlapping spectral content with respect to the combination of the second reference beam and the second object beam.

28. The method of claim 27, further comprising determining one or more of an image, a phase value or a depth profile associated with the object.
